(19) United States
(12) Patent Application Publication
(10) Pub. No.: US 2026/0210005 A1
(43) Pub. Date: Jul. 23, 2026

(54) Water-Holding Fabric, Filter, Humidifier and Method for Manufacturing Water-Holding Fabric

(71) Applicant: SHENZHEN CHENBEI TECHNOLOGY CO., LTD., SHENZHEN (CN)

(72) Inventor: Dehong Zhu, SHENZHEN (CN)

(73) Assignee: SHENZHEN CHENBEI TECHNOLOGY CO., LTD., SHENZHEN, GD (CN)

(21) Appl. No.: 19/077,996

(22) Filed: Mar. 12, 2025

(30) Foreign Application Priority Data
Jan. 23, 2025 (CN) 202510113581.8

(51) Int. Cl. D03D 25/00; B01D 39/08; D03D 1/00

(52) U.S. Cl. CPC D03D 25/005; B01D 39/08; D03D 1/00; B01D 2257/80; D10B 2401/022; D10B 2401/13; D10B 2403/033

(57) ABSTRACT

A water-holding fabric for a humidifier filter and a method for manufacturing the fabric includes at least two overlapping woven surfaces defining a first woven surface and a second woven surface. The first woven surface has a plurality of first air pores, with each of the first air pores defined by at least one first weaving thread, and first loops formed along the first weaving thread. The second woven surface has a plurality of second air pores, with each of the second air pores defined by at least one second weaving thread, and second loops formed along the second weaving thread. Connecting threads extending from the first loops to the second loops to connect the first woven surface and the second woven surface.

### CROSS REFERENCE TO RELATED APPLICTIONS

This Application claims the benefit of the priority filing date of Chinese patent application no. 202510113581.8, filed on Jan. 23, 2025, the content of which is incorporated herein by reference in its entirety.

### FIELD OF THE INVENTION

The present disclosure relates to a water-holding fabric, a filter, a humidifier, and a method for manufacturing a water-holding fabric.

### BACKGROUND

With the improvement of living standards, people have increasing requirements on their daily home environment. Air quality, particularly the regulation of air humidity, has been a major concern in improving the home environment. An evaporative humidifier absorbs water via a filter screen, and an airflow generated by a fan flows through the filter to carry the water on the filter to external environment so as to humidify the environment.

The filter mainly functions to hold water. However, existing filter designs usually do not provide for both good airflow unobstructedness and good water-holding capacity. This results in an insufficient humidification effect, and accordingly, does not meet a user's needs.

### SUMMARY

In view of this, in order to solve at least one of the foregoing technical problems, the present disclosure provides a water-holding fabric, a filter, a humidifier, and a method for manufacturing a water-holding fabric.

In order to achieve the objective described above, the present disclosure provides the following technical solutions.

In one aspect, the present disclosure provides a water-holding fabric, which includes at least two woven surfaces, the at least two woven surfaces being stacked, i.e., overlapping, and including a first woven surface and a second woven surface which may be adjacent to each other. The first woven surface includes a plurality of first air pores, each of the first air pores being defined by a plurality of first weaving threads that are connected, and first loops being formed at joints of adjacent first weaving threads. The second woven surface includes a plurality of second air pores, each of the second air pores being defined by a plurality of second weaving threads that are connected, and second loops being formed at joints of adjacent second weaving threads. Connecting threads extend from the first loops to the second loops to connect the first woven surface and the second woven surface.

Two connecting threads extend between a single first loop and/or a single second loop. Alternatively, no fewer than five of the connecting threads extend from a single first loop and/or a single second loop.

The connecting threads extending from at least one of the first loops extend toward the same second loop. The connecting threads may extend from at least one of the first loops extend toward at least two different second loops.

At least some of the connecting threads have a greater length between the first woven surface and the second woven surface than a distance between the first woven surface and the second woven surface such that the connecting threads between the first woven surface and the second woven surface are slack and curved. At least some of the connecting threads may be taut, extending linearly between the first woven surface and the second woven surface.

Projections of the first air pore and the second air pore overlap in a direction perpendicular to an extension surface of the first air pore. At least one of the first air pore and the second air pore may be oval, rectangular or hexagonal.

At least one of the first weaving thread, the second weaving thread, and the connecting thread includes a first filament. At least some of the first filaments have first depressions on their surfaces. The first depression may extend in a lengthwise direction of the first filament, or the first depression dot shaped.

At least one of the first weaving thread, the second weaving thread, and the connecting thread further may include a second filament made of a different material from the first filament, an antibacterial and mildew-proof composition, when a plurality of first filaments are provided, the antibacterial and mildew-proof composition being embedded between the first filaments, and a hydrophilic factor, when a plurality of first filaments are provided, the hydrophilic factor being embedded between the first filaments.

In another aspect, the present disclosure further provides a filter including at least one water-holding fabric according to any one of the foregoing implementations, and when a plurality of water-holding fabrics is provided, the plurality of water-holding fabrics is connected in a stacked manner or spaced apart.

In yet another aspect, the present disclosure further provides a humidifier, which includes the filter described above or at least one water-holding fabric described above.

In still another aspect, the present disclosure further provides a method for manufacturing a water-holding fabric. The method includes connecting first weaving threads to form a first woven surface having a plurality of first air pores, where each of the first air pores is defined by a plurality of first weaving threads that are connected, and adjacent first weaving threads are connected to form first loops, connecting second weaving threads to form a second woven surface having a plurality of second air pores, where each of the second air pores is defined by a plurality of second weaving threads that are connected, and adjacent second weaving threads are connected to form second loops, and introducing connecting threads to the second loops through the first loops to connect the first woven surface and the second woven surface.

According to the water-holding fabric, the filter, the humidifier and the method for manufacturing a water-holding fabric proposed in the present disclosure, the first air pores and the second air pores are provided to improve unobstructedness of airflow circulation and alleviate the problem of ineffective humidification due to the high resistance to airflow circulation, difficulty in propelling the airflow and insufficient flow rate caused by a water film on the water-holding fabric. Moreover, through the extension of the connecting threads between the first woven surface and the second woven surface, the contact between the connecting threads and the airflow provides a sufficient area for the contact between the airflow and water, which helps the airflow to carry sufficient moisture to achieve effective humidification. In the present disclosure, since the connecting threads are located between the first loops each formed by two weaving threads and the second loops each formed by two weaving threads, the insufficient supporting force of the weaving threads caused by the connection to single weaving threads is improved. Therefore, the impact to airflow circulation from the water film produced due to the insufficient opening area of the first air pores and the second air pores caused by the deformation of the weaving threads by pulling of the connecting threads is overcome. The shape stability of the connecting threads extending between the first woven surface and the second woven surface is also improved, and the connecting threads may not pile up or curve to occupy an airflow passage between the first air pores and the second air pores due to the deformation of the weaving threads by pulling. Furthermore, the dislocation of the first air pores and the second air pores caused by the change in the overall shape of the water-holding fabric due to the deformation of the weaving threads by pulling is avoided, thus improving the effect of continuous humidification.

### BRIEF DESCRIPTION OF THE FIGURES

FIG. 1 shows a structural schematic diagram of a water-holding fabric;

FIG. 2 shows a structural schematic partial diagram of a further water-holding fabric;

FIG. 3 shows a structural schematic diagram of a connection method of connecting threads;

FIG. 4 shows a structural schematic diagram of a further connection method of connecting threads;

FIG. 5 shows a structural schematic diagram of a first air pore;

FIG. 6 shows a structural schematic diagram of a further first air pore;

FIG. 7 shows a structural schematic diagram of a filter;

FIG. 8 shows a structural schematic diagram of a further filter; and

FIG. 9 shows a flowchart of a method for manufacturing a water-holding fabric.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof.

The drawings accompanying the application are for illustrative purposes only. They are not intended to limit the embodiments of the present application. Additionally, the drawings are not drawn to scale. Common elements between different figures may retain the same numerical designation.

In order to further illustrate the technical means, adopted to achieve the intended inventive purpose, and the efficacy of the present disclosure, specific implementations, structures, features and efficacy of a water-holding fabric provided according to the present disclosure are described in detail below with respect to the accompanying drawings and embodiments.

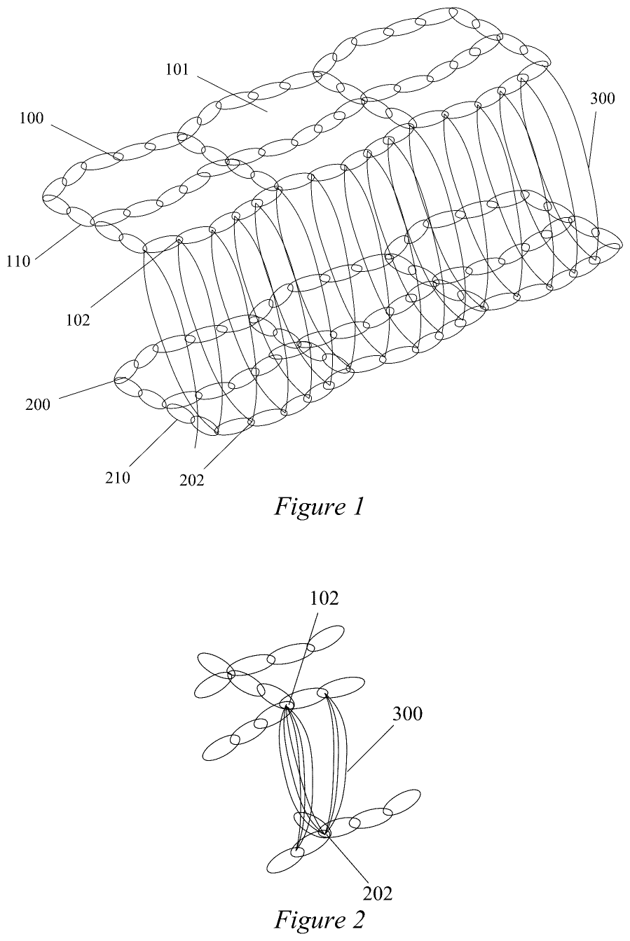

In one aspect, as shown in FIGS. 1 to 6, an embodiment of the present disclosure provides a water-holding fabric 10, including: at least two woven surfaces, the at least two woven surfaces being stacked and including a first woven surface 100 and a second woven surface 200 adjacent to each other. The first woven surface 100 includes a plurality of first air pores 101, each of the first air pores 101 being defined by a plurality of first weaving threads 110 that are connected in sequence or linked in a circle. Adjacent first weaving threads 110 are connected or linked to form first loops 102. The second woven surface 200 includes a plurality of second air pores 201, each of the second air pores 201 being defined by a plurality of second weaving threads 210 that are connected in sequence or linked in a circle, and adjacent second weaving threads 210 being connected or linked to form second loops 202. Connecting threads 300 extend from the first loops 102 to the second loops 202 to connect the first woven surface 100 and the second woven surface 200.

The water-holding fabric 10 may be used in an evaporative humidifier and serve as a filter for the evaporative humidifier. In the evaporative humidifier, the water-holding fabric 10 is connected to a support. The water-holding fabric 10 is wet by a structure capable of supplying water to the water-holding fabric 10, such as a sprayer, and the water-holding fabric 10 will hold moisture. An airflow is provided to the water-holding fabric 10 by an airflow propulsion device, such as a blower. The airflow flows at least from one side to the other side of the water-holding fabric 10, and then passes through at least the water-holding fabric 10 and carries the moisture on the water-holding fabric 10 into the environment, so as to enhance humidification of the environment. Therefore, the airflow permeability and the water-holding capacity of the water-holding fabric 10 are two important factors for improving the humidification effect.

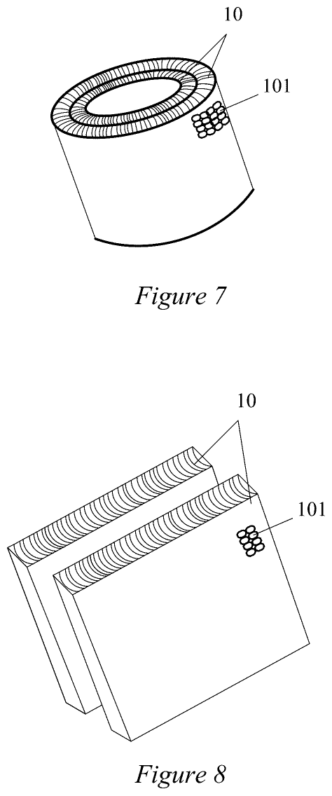

The woven surface has a certain thickness and is interwoven by weaving threads with a linear structure. As shown in FIG. 7, the woven surface may be a curved surface during use, and the woven surface may be defined as a cylinder. Alternatively, as shown in FIG. 8, the woven surface may be a flat surface. The water-holding fabric 10 may include a plurality of woven surfaces, and the structure of any of the woven surfaces may be the same or different. The plurality of woven surfaces may be stacked and spaced apart. The distance between the woven surfaces may be uniform or nonuniform. The distance between the woven surfaces is increased by means of the connecting threads 300. There may be only two woven surfaces as shown in FIG. 1, including the first woven surface 100 and the second woven surface 200. Alternatively, in some other implementations, there may be more woven surfaces, which may be set according to needs.

For example, in addition to the first woven surface 100 and the second woven surface 200 shown in FIG. 1, a third woven surface, a fourth woven surface, etc., are provided on a side of the first woven surface 100 facing away from the second woven surface 200. In the implementation where only the first woven surface 100 and the second woven surface 200 are included, if a higher water-holding capacity is required to achieve a better humidification effect, a plurality of water-holding fabrics 10 may be stacked closely in use as shown in FIG. 7, and the water-holding fabrics 10 are sewed along edges or fixed by, for example, fusion welding. Alternatively, the plurality of water-holding fabrics 10 may be spaced apart as shown in FIG. 8. The airflow passes through the respective water-holding fabrics 10 in sequence, and is in contact with the water on the different water-holding fabrics 10 a plurality of times, so that the moisture in the airflow is increased.

The plurality of first air pores 101 of the first woven surface 100 and the plurality of second air pores 201 of the second woven surface 200 are openings in the woven surfaces and are inlets and outlets for the airflow to pass through. The first air pores 101 and the second air pores 201 may be sized or shaped such that water is not easily stored therein, or that no water film will be formed on the first air pores 101 and the second air pores 201, and thus the first air pores 101 and the second air pores 201 only serve as passages, and the water-holding fabric 10 is improved with unobstructed airflow passages. The size or density of the first air pores 101 and the second air pores 201 may be set according to needs, such as depending on the airflow rate of the humidifier, the material of the first woven surface 100 and the second woven surface 200, and whether water used in the humidifier is doped with, for example, a fragrance agent which results in a change in the viscosity of water. This will be described later with respect to more specific implementations.

The first air pores 101 and the second air pores 201 are defined by weaving of filaments, and are densely arranged on the first woven surface 100 and the second woven surface 200. The weaving refers to connecting or linking of a plurality of weaving threads. The first air pore 101 is defined by a circle of first weaving threads 110, and the second air pore 201 is defined by a circle of second weaving threads 210. A plurality of first weaving threads 110 may be formed by continuously looping a single filament in a circle, and a plurality of second weaving threads 210 may be formed by continuously looping a single filament in a circle. As shown in FIG. 1, the first weaving threads 110 or the second weaving threads 210 are not used only for defining a single first air pore 101 or a single second air pore 201.

In an example of the first weaving threads 110, adjacent sides of two adjacent first air pores 101 are formed of the same first weaving threads 110, i.e., at least some of the first weaving threads 110 are used for defining two adjacent first air pores 101. Alternatively, in some implementations, the first weaving threads 110 may be shared by more first air pores 101, such as three first air pores 101 or four first air pores 101.

Hereinafter, in an example of the first air pore 101, the first weaving thread 110 is of a loop structure defined by a strip-shaped filament. For ease of illustration, two adjacent first weaving threads 110 are referred to as a front weaving thread and a rear weaving thread respectively, the connection between the two adjacent first weaving threads 110 refers to that the front weaving thread and the rear weaving thread run across each other and then the rear weaving thread will take up part of an opening of the front weaving thread, and a space formed between the rear weaving thread and the front weaving thread within the opening of the front weaving thread is referred to as the first loop 102 described above. Alternatively, it can be seen that the first loop 102 is an area belonging to the opening of the front weaving thread and also an area belonging to an opening of the rear weaving thread, and accordingly is a common area for the front weaving thread and the rear weaving thread. A plurality of first weaving threads 110 may be formed by continuously looping a single filament in a circle, and a plurality of second weaving threads 210 may be formed by continuously looping a single filament in a circle.

The connecting threads 300 extend from the first loops 102 to the second loops 202, alternatively, they may extend from the second loops 202 to the first loops 102. The connecting threads 300 extend between the first woven surface 100 and the second woven surface 200, and the connecting threads 300 extend from the first loops 102 to the second loops 202 to function in supporting the distance between the first woven surface 100 and the second woven surface 200 and connecting the first woven surface 100 and the second woven surface 200. Importantly, the connecting threads 300 extend from the first loops 102 to the second loops 202 such that the water-holding fabric 10 achieves a water-holding effect.

Expanding on this, in a first aspect, the connecting threads 300 extend from the first loops 102 to the second loops 202 to function in moisture transfer: the connecting threads 300 connect the first woven surface 100 and the second woven surface 200, and act as a bridge for moisture transfer between the first woven surface 100 and the second woven surface 200, so that moisture can be efficiently transferred from one of the first woven surface 100 and the second woven surface 200 to the other. This design allows moisture to be diffused and retained throughout the water-holding fabric 10 from a position, closest to or in contact with a source of water supply, of the water-holding fabric 10, so that the fabric will not lose its humidification capacity due to drying.

In a second aspect, the connecting threads 300 extend from the first loops 102 to the second loops 202 to fix the first woven surface 100 and the second woven surface 200, alleviating the problem of uneven distribution of moisture caused by offset. The connecting threads 300 between the first loops 102 and the second loops 202 form a strong and direct connection, which combines the first woven surface 100 and the second woven surface 200 together more tightly. This connection reduces the relative movement of the first woven surface 100 and the second woven surface 200, improves offset caused by airflow, vibration, or changes in water pressure during use, achieves uniform distribution of moisture, and alleviates the problem of poor airflow circulation caused by the offset.

In a third aspect, the connecting threads 300 serve to enhance the evaporation efficiency and improve the continuous water supply capacity of the water-holding fabric 10. As the connecting threads 300 extend from the first loops 102 to the second loops 202 to enhance the continuous flow of moisture between the first woven surface 100 and the second woven surface 200, the humidity of both the first woven surface 100 and the second woven surface 200 can be increased continuously, thereby expanding the evaporation area.

The continuous water supply and relatively balanced moisture distribution enable more moisture to be effectively evaporated when the airflow passes through the water-holding fabric 10, thus enhancing the humidification effect. In a fourth aspect, the connecting threads 300 extend from the first loops 102 to the second loops 202 to serve to improve the overall strength of the fabric and enhance the overall structural stability. The connection form of the connecting threads 300 enhances the overall structural strength of the water-holding fabric 10. In an extended humidification process and air circulation, this strength may prevent the water-holding fabric 10 from being distorted or damaged due to the gravity of moisture and the airflow, and even in an environment with high humidity and strong airflow, the shape of the water-holding fabric 10 when it works efficiently may still be maintained to a certain extent by the connection method of the connecting threads 300. Moreover, the deformation of the water-holding fabric 10 caused by pulling during brushing, mounting and removal of the water-holding fabric 10 may be avoided, thereby improving durability and reducing the risk of wear and diminished humidification effectiveness. The stable structure contributes to maintaining long-term performance of the humidifier.

Under the action of an external wind component such as a blower, a centrifugal fan and an axial-flow fan, the airflow passes through the first air pores 101 and the second air pores 201 and comes into contact with the moisture on the connecting threads 300 between the first air pores 101 and the second air pores 201, so that the pressure loss of the airflow passing through the first woven surface 100 and the second woven surface 200 is reduced, and the noise caused by the impact of the airflow on the first woven surface 100 and the second woven surface 200 is reduced.

As the connecting threads 300 hold a considerable amount of moisture, the moisture contact area in a flow path of the airflow is increased, the contact efficiency of the airflow with water is improved, and the airflow will have sufficient humidity after flowing through the water-holding fabric 10. The connecting threads 300 themselves will hold water. Since a plurality of connecting threads 300 are provided and a water film will be formed between the connecting threads 300, the amount of water that can be contacted by the airflow is further increased, greatly increasing the water-holding efficiency.

The connecting threads 300 may be connected by various methods. For example, a single connecting thread 300 runs or passes through a first loop 102 to form two connecting threads 300 introduced through the first loop 102. A single connecting thread 300 runs or passes through a second loop 202 to form two connecting threads 300 introduced through the second loop 202. As shown in FIG. 1, it is possible that a connection is made by the connecting thread 300 sequentially passing through a previous first loop 102, a previous second loop 202, a following first loop 102, and a following second loop 202, thus achieving easy weaving and high structural strength. In some other implementations, it is also possible that the connecting thread 300 is introduced through the first loop 102 or the second loop 202 by bonding. As in the foregoing implementation in which the connecting thread 300 passes through the first loop 102, only an even number of connecting threads 300 can be introduced through the first loop 102, whereas an odd or even number of connecting threads 300 can be introduced through the first loop 102 by bonding, such as ultrasonic welding.

In addition, the first loop 102 is not formed by linking only two first weaving threads 110, but may be formed by linking three or more first weaving threads 110 depending on the position, and a plurality of first weaving threads 110 may be formed by continuously looping a single filament in a circle. As shown in FIG. 2, a first loop 102 is formed by linking three first weaving threads 110. The connecting threads 300 pass through the first loops 102 to improve the connection and support of the first woven surface 100 and the second woven surface 200, instead of being connected to the first weaving threads 110. The structure in which two or more first weaving threads 110 are linked to each other to form the first loop 102 is more stable, and can provide a stronger support to the connecting threads 300. The stress on an edge of the first loop 102 is as a joint stress of two or even more first weaving threads 110, and accordingly, the shape of the first loop 102 is not easy to change, the stability of the shape and area of the first air pore 101 and the shape of the connecting threads 300 can be improved, and the preset air permeability as well as the water-holding capacity can be increased and will not undergo a significant decline after long-term use. It can be understood that the connecting threads 300 have the same advantages over the second loops 202 and the second weaving threads 210 as analyzed previously.

It is worth noting that, in order to make the diagrams show the structure more clearly, only a part of the structure is shown in FIGS. 1 to 4 of the present disclosure, and only some of the connecting threads 300 are drawn therein, while the rest of the connecting threads 300 can be set with reference to the part shown, thus forming a complete water-holding fabric 10.

According to the water-holding fabric 10, the filter and the humidifier proposed in the embodiments of the present disclosure, by providing the first air pores 101 and the second air pores 201, and using the connecting threads 300 to extend between the first air pores 101 and the second air pores 201, the connecting threads 300 extend from the first loops 102 to the second loops 202 to fix the first woven surface 100 and the second woven surface 200, thus improving the unobstructedness of airflow circulation, and alleviating the problem of high resistance to airflow circulation due to the water film on the water-holding fabric 10, and alleviating the problem of ineffective humidification due to the difficulty in propelling the airflow and the insufficient flow rate.

Moreover, through the extension of the connecting threads between the first woven surface 100 and the second woven surface 200, the contact between the connecting threads 300 and the airflow provides a sufficient area for the contact between the airflow and water, which helps the airflow to carry sufficient moisture to achieve effective humidification. In the present disclosure, since the connecting threads 300 are located between the first loops 102 and second loops 202 each formed by two weaving threads 110, the insufficient supporting force of the weaving threads 110 caused by the connection to single weaving threads 110 is improved.

Therefore, the impact to airflow circulation from the water film produced due to the insufficient opening area of the first air pores 101 and the second air pores 201 caused by the deformation of the weaving threads 110 by pulling of the connecting threads 300 is overcome. The shape stability of the connecting threads 300 extending between the first woven surface 100 and the second woven surface 200 is also improved, and the connecting threads 300 may not pile up or curve to occupy an airflow passage between the first air pores 101 and the second air pores 201 due to the deformation of the weaving threads 110 by pulling; and furthermore, the dislocation of the first air pores 101 and the second air pores 201 caused by the change in the overall shape of the water-holding fabric 10 due to the deformation of the weaving threads 110 by pulling is avoided, thus improving the effect of continuous humidification.

In an implementation, two connecting threads 300 extend from a single first loop 102 and/or a single second loop 202. For example, the connecting thread 300 may be connected in such a manner that a single connecting thread 300 passes through the first loop 102 and the second loop 202 as shown in FIG. 1. Alternatively, in some other implementations, there may be no less than five connecting threads 300 extending from a single first loop 102 and/or a single second loop 202, such as five, six, or more connecting threads, and accordingly the number of connecting threads 300 is greater, the connecting threads 300 are denser, and it is easier to form the water film between the connecting threads 300, so that the amount of water that can be held by the connecting threads 300 is greatly increased, the contact area between the airflow and the moisture is increased, and the humidification efficiency is improved with a limited volume of water-holding fabric.

The number of connecting threads 300 may be set according to the ventilation situation. For example, when the air flow rate is small or the fan gear is low and the rotational speed is relatively small, for a single first loop 102 and/or a single second loop 202, the number of connecting threads 300 extending therefrom is no more than thirty, thus alleviating the problem of obstruction of airflow circulation because the excessive connecting threads 300 expand into an airflow passage between the first air pores 101 and the second air pores 201. Furthermore, the number of connecting threads 300 may be set according to thickness. For example, when the connecting threads 300 are thicker, the diameter of the threads is ≥80 μm, and accordingly, by controlling the number of connecting threads 300 to be less than twenty, it helps to alleviate the problem that the number of first air pores 101 and second air pores 201 in a limited area is reduced because the first loops 102 and/or the second loops 202 are too large. It also helps to alleviate the problem that the moisture held on the connecting threads 300 cannot be used fully due to a small contact area between the airflow and a single connecting thread 300 caused by overcrowding of the connecting threads 300.

The number of first loops 102 and second loops 202 may be the same and may be set in correspondence, or the number of first loops 102 and second loops 202 may be different. It may be that each first loop 102 has a connecting thread 300 connected therein, or some of the first loops 102 have a connecting thread 300 connected therein. For example, a previous first loop 102 has a connecting thread 300 connected therein, one or a plurality of first loops 102 spaced apart in the middle have no connecting thread 300 connected therein, and a following first loop 102 has a connecting thread 300 connected therein. Such an arrangement may reduce the number of connections, and reduce the difficulty in weaving. Besides, the density of the connecting threads 300 may be adjusted on the basis of the number of the connecting threads 300 connected in the first loops 102. For the second loops 202, each of the second loops 202 may have a connecting thread 300 connected therein, or some of the second loops 202 may have a connecting thread 300 connected therein. Examples of several connection methods are given below, and it can be understood that the following connection methods may be used in combination.

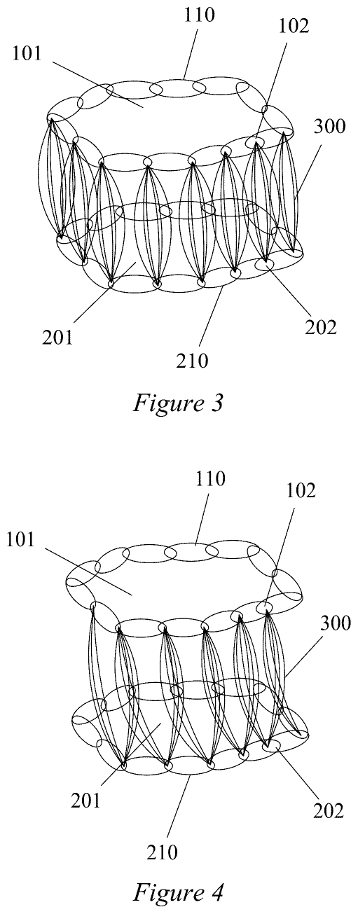

The connection of the connecting threads 300 between the first loops 102 and the second loops 202 may be shown in FIG. 3. For any of the connecting threads 300, the connecting thread 300 extending from at least one of the first loops 102 extends toward the same second loop 202, i.e., the connecting thread 300 runs between the current first loop 102 and the current second loop 202 repeatedly, forming a plurality of connecting threads 300 passing from the first loop 102 to the second loop 202. With such a connection method, the misalignment of the first woven surface 100 and the second woven surface 200 can be overcome through the restriction of the connecting threads 300, i.e., by this connection method, the relative position of the first woven surface 100 and the second woven surface 200 can be fixed effectively.

It may also be that the connecting threads 300 extending from at least one of the first loops 102 extend toward at least two different second loops 202. Alternatively, the connecting threads 300 extending from at least two first loops 102 extend toward the same second loop 202. As shown in FIG. 4, by the way that the connecting threads 300 extending from a first loop 102 extend toward two different second loops 202 and the connecting threads 300 extending from the same second loop 202 extend into two first loops 102, the number of the connecting threads 300 may be controlled to adjust the spacing between the connecting threads 300, and tiny gaps are formed between the connecting threads 300 to achieve the effect of capillary suction so as to realize uniform distribution of moisture while realizing continuous transfer of moisture. Moreover, the extension length of the connecting threads 300 may be increased, which boosts the water-holding capacity of a single connecting thread 300. The reasonable setting of the spacing between the connecting threads 300 helps to enhance the water film between the connecting threads 300, thus further increasing the water-holding capacity of the connecting threads 300.

In addition, it may also be that the connecting threads 300 extending from the first loop 102 extend toward more second loops 202, such as three second loops.

In an implementation, at least some of the connecting threads 300 have a greater length between the first woven surface 100 and the second woven surface 200 than a distance between the first woven surface 100 and the second woven surface 200 such that the connecting threads 300 between the first woven surface 100 and the second woven surface (200) are curved. The curved form of the connecting thread 300 can increase the length of a single connecting thread 300, which increases the water-holding capacity of the connecting thread 300 itself. It can be viewed as a circulation path of the airflow between the first air pore 101 and the second air pore 201 being a curved path, which is a longer path and brings more opportunities for contact with water, thus further increasing the water-holding capacity of the airflow. Moreover, the area of the water film formed between adjacent connecting threads 300 may be increased, which further increases the total water-holding capacity of the plurality of connecting threads 300. The connecting thread 300 may be curved as an arc, or in some implementations, the connecting thread 300 may be alternately curved in a plurality of directions, and the connecting thread 300 may be helically coiled, such as in the shape of a spring, so that the water-holding capacity of the connecting thread 300 can be further increased.

Alternatively, at least some of the connecting threads 300 extend linearly between the first woven surface 100 and the second woven surface 200, so that the air permeability between the first air pores 101 and the second air pores 201 can be increased, and the difficulty in weaving the connecting threads 300 can be reduced.

In one implementation, the number of the first air pores 101 and the second air pores 201 is the same, forming passages where the first air pores 101 correspond to the second air pores 201. The number of the first air pores 101 and the second air pores 201 may be different, where one first air pore 101 may correspond to a plurality of second air pores 201 to form a passage, or a plurality of first air pores 101 may correspond to a single second air pore 201 to form a passage. The size of the first air pores 101 and the second air pores 201 may be the same or may be different. For example, it may be that the first air pore 101 is at the front end of a flow direction of the airflow and the size of the first air pore 101 is smaller than that of the second air pore 201, alleviating the problem that the water film is formed on the second air pore 201 due to blocking of the airflow with high moisture at the second air pore 201. Alternatively, it may also be that the size of the first air pore 101 is larger than that of the second air pore 201, so that the airflow passage between the first air pore 101 and the second air pore 201 has a tendency of tightening, which increases the pressure from the airflow onto the connecting thread 300 between the first air pore 101 and the second air pore 201, increases the contact strength between the airflow and moisture on the connecting thread 300 and makes it easy for the airflow to carry the moisture.

The relative position of the first air pore 101 and the second air pore 201 may be various. For example, the surface where the first air pore 101 is located may be approximated as a plane, projections of the first air pore 101 and the second air pore 201 at least partially overlap in a direction perpendicular to the plane where the first air pore 101 is located, and the projections with a high degree of overlap provide the airflow with a passage perpendicular to the plane where the first air pore 101 is located, thus improving the unobstructedness of airflow circulation. Alternatively, it may also be that the projections of the first air pore 101 and the second air pore 201 in the direction perpendicular to an extension surface of the first air pore 101 partially overlap with each other, i.e., the first air pore 101 and the second air pore 201 are staggered to provide the airflow with a passage that is inclined to the plane where the first air pore 101 is located. Therefore, under the limitation on the distance between the first woven surface 100 and the second woven surface 200, the length of the airflow passage is increased, the length of the connecting thread 300 is extended, and the contact time between the airflow and the connecting thread 300 is prolonged, so that the water-holding capacity of the airflow is increased.

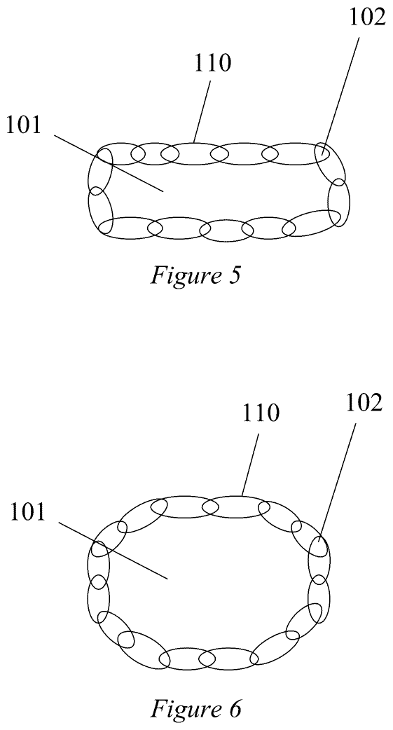

The first air pore 101 and the second air pore 201 may have various shapes. The first air pore 101 and the second air pore 201 may be regular circular, oval, triangular or polygonal, or the first air pore 101 and the second air pore 201 may have an irregular shape. For example, at least one of the first air pore 101 and the second air pore 201 has an irregular oval shape, or may have an irregular rectangular shape as shown in FIG. 5, or an irregular hexagonal shape as shown in FIG. 6, where the irregular hexagonal shape may be referred to as a hexagonal-like shape. Openings of the plurality of first air pores 101 and the plurality of second air pores 201 may be of different shapes, e.g., may be a combination of a hexagon and a triangle.

The size of the different first air pores 101 and second air pores 201, the density of the connecting threads 300, and the thickness of the water-holding fabric 10 do not exist independently and interact with one another, which constrain the water-holding capacity and the water-holding effect after airflow circulation collaboratively. The present disclosure provides the following specific data for reference, and the following data collaboratively achieves a good humidification effect

The first air pore 101 or the second air pore 201 is in the shape of a hexagon, the length of a long diagonal of the hexagon is greater than or equal to three millimeters and less than or equal to five millimeters, and the length of a short diagonal of the hexagon is greater than or equal to two millimeters and less than or equal to three millimeters. If the air pore is in the shape of a polygon, the diagonal refers to a line segment connecting any two non-adjacent vertices in the polygon, the short diagonal refers to a shortest line segment between any two non-adjacent vertices, and the long diagonal refers to a line segment between any two non-adjacent vertices that is longer than the short diagonal. If the air pore is in the shape of a circle or an oval, the diagonal refers to a line segment connecting any two points on the circle.

A chord may be viewed as a “diagonal” of a circle, where the long diagonal refers to a longest chord, i.e., the diameter, of the circle or oval, and the short diagonal refers to a line segment between any two points that is shorter than the long diagonal. The water-holding fabric 10 has a thickness greater than or equal to three millimeters and less than or equal to eight millimeters. The density of the connecting threads 300 includes a warp density greater than or equal to thirty threads per inch and less than or equal to thirty six threads per inch, and a weft density greater than or equal to twenty four threads per inch and less than or equal to twenty six threads per inch. When a plurality of water-holding fabrics 10 are stacked in use, the number of layers of the water-holding fabrics 10 is less than four, thus alleviating the problem of excessive wind resistance caused by the superposition of positional differences between layers when the number of layers is too large.

The individual fibers to be spun into a weaving thread are referred to as filaments. At least one of the first weaving thread 110, the second weaving thread 210 and the connecting thread 300 includes a first filament. In an example of the first weaving thread 110, it can be understood that the following characterization of the filament in the first weaving thread 110 is applicable to that in the second weaving thread 210 and the connecting thread 300. The first weaving thread 110 may be compactly spun with a plurality of first filaments densely, such as 140 to 150 first filaments.

In one implementation, at least some of the first filaments have first depressions on their surfaces, each of the first depressions may be a depression extending in a length direction of the first filament, or may be a depression extending in a circumferential or random direction, and the depression may be a narrow fine line or a wide groove. For example, a first depression extending in the length direction of the first filament may be provided on each side of the first filament in the circumferential direction, so that the first filament in the length direction may have a special-shaped cross-section, such as a triangle with each side concave inwardly or a square with each side concave inwardly. This helps to increase the area of a water-holding surface of the first filament, and can achieve effective water holding, increase the contact area between the airflow and water, and improve the humidification efficiency.

The first depression may not be a bar-shaped depression, but a dot-shaped depression, which makes the first filament have an uneven, rough surface. The rough surface may be formed by physical deposition on the surface of the first filament, so that the first filament has the uneven surface, which helps to increase the area of the water-holding surface, and can achieve effective water holding, increase the contact area between the airflow and the water, and improve the humidification efficiency. The height difference between a protrusion of the rough surface and a concave portion may be above 0 μm and below 100 μm.

It may be that the first depressions of the first filaments included in different first weaving threads 110 have the same shape, for example, the first weaving threads 110 are composed of the first filaments having the same cross-section shape. However, the first filaments may have different degrees of softness and hardness due to the first depressions at different positions. In order to increase the strength of the edge of the first air pore 101 while achieving a good water-holding capacity, the first depressions of the first filaments included in different first weaving threads 110 may have different shapes, i.e., the different first weaving threads 110 may be spun with first filaments having different cross-section shapes. The first depressions of different first filaments in the same first weaving thread 110 have the same or different shapes, i.e., the first weaving thread 110 may be compactly spun with a plurality of first filaments having the same cross-section shape, or the first weaving thread 110 may be compactly spun with a plurality of first filaments having different cross-section shapes.

In an implementation, the first weaving thread 110 further includes a second filament made of a different material from the first filament. The material of the filament may be softer, which has better formability, or it may be harder, which has good structural strength and is less prone to deformation after long-term use. The filament itself may have good water absorbency, e.g., it may be made of a cotton material, which improves the water-holding capacity. Alternatively, the filament itself may be non-absorbent, and the water-holding capacity is improved relying on the surface depressions or roughness, thus scale accumulation in the filament is reduced. The strength and water absorbency of the first weaving thread 110 can be changed by mixing a variety of different filaments according to preference. For example, the first filament may be non-absorbent and capable of holding water only at its surface, while the second filament may absorb water; or the hardness of the first filament may be greater than that of the second filament.

In some implementations, the first weaving thread 110 further includes an antibacterial and mildew-proof composition embedded between the first filaments or between the first filaments and the second filaments. That is, when a plurality of first filaments or the first filaments and the second filaments are spun together to form the first weaving thread 110, the antibacterial and mildew-proof composition is added to be combined and spun with the first and second filaments. The embedded addition of the composition overcomes the disadvantages that the antibacterial and mildew-proof composition coated after the formation of the first weaving thread 110 easily falls off and that the work process is cumbersome.

In some implementations, the first weaving thread 110 further includes a hydrophilic factor embedded between the first filaments or between the first filaments and the second filaments. That is, the hydrophilic factor is added when a plurality of first filaments or the first filaments and the second filaments are spun together to form the first weaving thread 110, e.g., poly(butyl acrylate), methyl methacrylate and the like may be added during the weaving process. The embedded addition of the composition overcomes the disadvantages that the hydrophilic layer coated after the formation of the first weaving thread 110 easily falls off and that the work process is cumbersome.

In addition, if the connecting thread 300 may include only a single first filament, the method of coating the antibacterial and mildew-proof composition and the hydrophilic factor may be used to improve the performance of the connecting thread 300.

The water-holding fabric 10 may be of various colors, e.g., it may be non-white, such as grey, light brown, yellow, and blue. It is not easy to find scale and other debris deposited on the water-holding fabric 10, and accordingly the water-holding fabric is less prone to discoloring after long-term use, and the impact to the appearance due to irregular color and yellowing of the water-holding fabric 10 caused by scale accumulation is overcome.

In another aspect, the present disclosure further provides a filter, including at least one water-holding fabric 10 according to any one of the foregoing implementations, one or more water-holding fabrics 10 may be provided according to needs, and the water-holding fabric 10 may be defined as a cylinder as shown in FIG. 7, or may be flattened as shown in FIG. 8. When a plurality of water-holding fabrics 10 are used, the plurality of water-holding fabrics 10 may be densely connected as shown in FIG. 7 and fixed by edge sewing, and may be sleeved over a single holder integrally. Alternatively, the water-holding fabrics may be spaced apart as in FIG. 8, each using a fixing device.

The filter includes the water-holding fabric 10 in any of the foregoing implementations, and has the advantages of the water-holding fabric 10 in any of the foregoing implementations, which will not be repeated herein.

In yet another aspect, the present disclosure further provides a humidifier including the filter as described above, a support, a water supply mechanism, and an airflow propulsion mechanism, where the filter is connected to the support, and the water supply mechanism supplies water to a water-holding fabric 10 of the filter by a sprayer or the like, so that the water-holding fabric 10 holds water. The airflow propulsion mechanism provides an airflow to the water-holding fabric 10 by a blower and the like. The airflow flows from one side to the other side of the water-holding fabric 10, and then passes through the water-holding fabric 10 and carries the moisture on the water-holding fabric 10 into the environment, to enhance humidification of the environment.

The humidifier includes at least one filter in any of the above embodiments and has the advantages of any of the filters as described above, which will not be repeated herein.

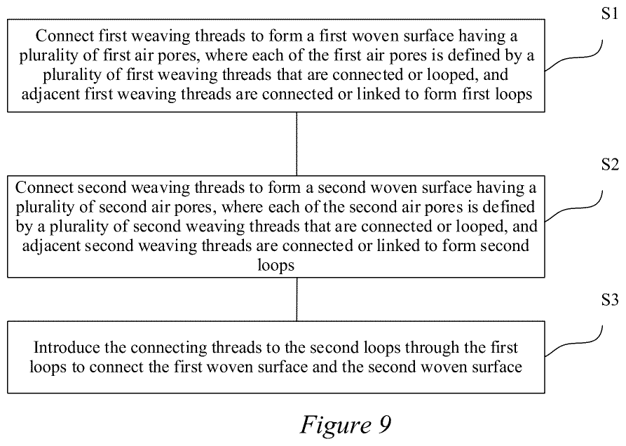

In still yet another aspect, as shown in FIG. 9, the present disclosure further provides a method for manufacturing a water-holding fabric, which may be used for processing and forming a water-holding fabric according to any of the foregoing implementations, the method including the following steps.

In step S1, first weaving threads 110 are connected to form a first woven surface 100 having a plurality of first air pores 101, where each of the first air pores 101 is defined by a plurality of first weaving threads 110 that are connected or looped, and adjacent first weaving threads 110 are connected or linked to form first loops 102.

In step S2, second weaving threads 210 are connected to form a second woven surface 200 having a plurality of second air pores 201, where each of the second air pores 201 is defined by a plurality of second weaving threads 210 that are connected or looped, and adjacent second weaving threads 210 are connected or linked to form second loops 202.

At least one of the first weaving thread 110 and the second weaving thread 210 is a yarn composed of a single or a plurality of first filaments. In some implementations, at least one of the first weaving thread 110 and the second weaving thread 210 further includes a second filament made of a material different from that of the first filament, a hydrophilic factor and/or an antibacterial and mildew-proof composition, and the second filament, the hydrophilic factor and/or the antibacterial and mildew-proof composition are spun together with the first filament to form the first weaving thread 110 and/or the second weaving thread 210. The first woven surface 100 and the second woven surface 200 may be formed in the same way. In an example of the first woven surface 100, yarns can be formed into loops by means of a netting machine to form the first weaving threads 110, and the first weaving threads 110 are connected or linked in sequence to form the first woven surface 100 having a plurality of first air pores 101.

The size of the first air pore 101 can be changed by changing the length of the first weaving threads 110 or the number of first weaving threads 110 defining the first air pore 101, and the shape of the first air pore 101 can be changed based on the connection relationship and positions of the plurality of first weaving threads 110, so that the problem that there will be no water film or it is difficult to form the water film on the first air pore 101 and the second air pore 201 can be alleviated. As shown in FIG. 1, the first weaving threads 110 or the second weaving threads 210 are not used only for defining a single first air pore 101 or a single second air pore 201. In an example of the first weaving threads 110, adjacent sides of two adjacent first air pores 101 are formed of the same first weaving threads 110, i.e., at least some of the first weaving threads 110 are used for defining two adjacent first air pores 101. Alternatively, in some implementations, the first weaving threads 110 may be shared by more first air pores 101, such as three first air pores 101 or four first air pores 101.

Two adjacent first weaving threads 110, as well as adjacent second weaving threads 210, are connected or linked to each other, and holes are formed at joints by means of connecting or linking. In an example of the first air pore 101, for ease of illustration, two adjacent first weaving threads 110 are referred to as a front weaving thread and a rear weaving thread respectively, and the linking between the two adjacent first weaving threads 110 refers to that the front weaving thread and the rear weaving thread run across each other, and then the rear weaving thread will take up part of an opening of the front weaving thread, and a space formed, between the rear weaving thread and the front weaving thread, within the opening of the front weaving thread, is referred to as the first loop 102 described above.

Alternatively, it can be seen that the first loop 102 is an area belonging to the opening of the front weaving thread and also an area belonging to an opening of the rear weaving thread, and accordingly is a common area for the front weaving thread and the rear weaving thread. In addition, the first loop 102 is not formed by linking only two first weaving threads 110, but may be formed by linking three or more first weaving threads 110 depending on the position. As shown in FIG. 2, three first weaving threads 110 are linked to form the first loop 102.

The above weaving process may form only the first woven surface 100 and the second woven surface 200. Alternatively, more woven surfaces may be formed, such as a third woven surface, a fourth woven surface, and a fifth woven surface.

In step S3, the connecting threads 300 are introduced to the second loops 202 through the first loops 102 to connect the first woven surface 100 and the second woven surface 200.

The connecting thread 300 is a yarn formed by a single or a plurality of first filaments. In some implementations, the connecting thread 300 further includes a second filament made of a material different from the first filament, a hydrophilic factor and/or an antibacterial and mildew-proof composition, and the second filament, the hydrophilic factor and/or the antibacterial and mildew-proof composition are spun together with the first filament to form the connecting thread 300.

After the first woven surface 100 and the second woven surface 200 or even more woven surfaces are formed, the plurality of woven surfaces are stacked and connected each other. For example, if the woven surface includes only the first woven surface 100 and the second woven surface 200, the first woven surface 100 and the second woven surface 200 are stacked and spaced apart, and the distance between the first woven surface 100 and the second woven surface 200 may be uniform or nonuniform, where the distance may be determined according to the humidification demand, the viscosity of water, the size of meshes, and the number of connecting threads 300, and the like.

The way in which the connecting threads 300 extend from the first loops 102 to the second loops 202 may be various. For example, it may be that a single connecting thread 300 runs or passes through a first loop 102 to form two connecting threads 300 introduced through the first loop 102, and a single connecting thread 300 runs or passes through a second loop 202 to form two connecting threads 300 introduced through the second loop 202. As shown in FIG. 1, it is possible that a connection is made by the connecting thread 300 sequentially passing through a previous first loop 102, a previous second loop 202, a following first loop 102 and a following second loop 202, that is, a plurality of first loops 102 and second loops 202 can be connected by using only a single connecting thread 300.

The entire first woven surface 100 and the second woven surface 200 can be connected by only one connecting thread 300, or a certain number of first air pores 101 and second air pores 201 can be connected by one connecting thread 300, e.g., every ten rows of first air pores 101 can be connected by a single connecting thread 300. The number of times the connecting thread 300 passes through the first loop 102 and the second loop 202 is reduced by the way of threading of the connecting thread 300, thus achieving a simple structure, easy weaving and manufacturing, and low costs. In some other implementations, it is also possible that the connecting thread 300 is introduced through the first loop 102 or the second loop 202 by bonding. As in the foregoing implementation in which the connecting thread 300 passes through the first loop 102, only an even number of connecting threads 300 can be introduced through the first loop 102, whereas an odd or even number of connecting threads 300 can be introduced through the first loop 102 by bonding, such as ultrasonic welding.

The connecting threads 300 pass through the first loops 102 and the second loops 202 to connect the first woven surface 100 and the second woven surface 200 and support the distance between the first woven surface 100 and the second woven surface 200, instead of being connected to the first weaving threads 110. The structure in which two or more first weaving threads 110 are connected or linked to each other to form the first loops 102 is more stable, and can provide a stronger support to the connecting threads 300. The stress on the edge of the first loop 102 is as a joint stress of two or even more first weaving threads 110, and accordingly, the shape of the first loop 102 is not easy to change, the stability of the shape and area of the first air pore 101 and the shape of the connecting threads 300 can be improved, and the preset air permeability as well as the water-holding capacity can be increased and will not undergo a significant decline after long-term use. It can be understood that the connecting threads 300 have the same advantages over the second loops 202 and the second weaving threads 210 as analyzed previously.

In the implementation of the present disclosure, as the connecting threads 300 are provided between the first woven surface 100 and the second woven surface 200 to connect the two and support therebetween, in a first aspect, the connecting threads 300 extend to the second loops 202 from the first loops 102 function in moisture transfer. The connecting threads 300 extend from the first loops 102 to the second loops 202 to connect the first woven surface 100 and the second woven surface 200, and act as a bridge for moisture transfer between the first woven surface 100 and the second woven surface 200, so that moisture can be efficiently transferred from one of the first woven surface 100 and the second woven surface 200 to the other.

This design allows moisture to be diffused and retained throughout the water-holding fabric 10 from a position, closest to or in contact with a source of water supply, of the water-holding fabric 10, so that the problem that the fabric loses its humidification capacity due to drying is alleviated. In a second aspect, the connecting threads 300 serve to enhance the evaporation efficiency and improve the continuous water supply capacity of the water-holding fabric 10. With the connecting threads 300, the continuous flow of moisture between the first woven surface 100 and the second woven surface 200 is realized, and the humidity of both the first woven surface 100 and the second woven surface 200 can be increased continuously, thereby expanding the evaporation area. The continuous water supply and relatively balanced moisture distribution enable more moisture to be effectively evaporated when the airflow passes through the water-holding fabric 10, thus enhancing the humidification effect.

In a third aspect, the connecting threads 300 serve to improve the overall strength of the fabric and enhance the overall structural stability: the connection form of the connecting threads 300 enhances the overall structural strength of the water-holding fabric 10. In an extended humidification process and air circulation, this strength may prevent the water-holding fabric 10 from being distorted or damaged due to the gravity of moisture and the airflow, and even in an environment with high humidity and strong airflow, the shape of the water-holding fabric 10 when it works efficiently may still be maintained to a certain extent by the connection method of the connecting threads 300. Moreover, deformation of the water-holding fabric 10 caused by pulling during brushing, mounting and removal of the water-holding fabric 10 may be avoided, thereby improving durability and reducing the risk of wear and diminished humidification effectiveness.

The stable structure contributes to maintaining long-term performance of the humidifier. In a fourth aspect, the first woven surface 100 and the second woven surface 200 are fixed, alleviating the problem of uneven distribution of moisture caused by offset. The connecting threads 300 between the first loops 102 and the second loops 202 form a strong and direct connection, which combines the first woven surface 100 and the second woven surface 200 together more tightly. This connection reduces the relative movement of the first woven surface 100 and the second woven surface 200, alleviates the problem of offset caused by airflow, vibration, or changes in water pressure during use, achieves uniform distribution of moisture, and helps to alleviates the problem of poor airflow circulation caused by the offset.

The foregoing descriptions are merely specific implementations of the present disclosure, but the protection scope of the present disclosure is not limited thereto. Any modification or replacement easily conceived by a person skilled in the art within the technical scope of the present disclosure should fall within the protection scope of the present disclosure. Therefore, the protection scope of the present disclosure shall be the protection scope of the claims.

What is claimed is:

1. A water-holding fabric, comprising:
at least two overlapping woven surfaces comprising a first woven surface and a second woven surface;
wherein the first woven surface comprises a plurality of first air pores, with each of the plurality of first air pores being defined by at least one first weaving thread and a plurality of first loops formed along the at least one first weaving thread;
wherein the second woven surface comprises a plurality of second air pores, with each of the plurality of second air pores being defined by at least one second weaving thread, and a plurality of second loops formed along the at least one second weaving thread; and
a plurality of connecting threads extending between the plurality of first loops and the plurality of second loops, thereby connecting the first woven surface to the second woven surface to form the water-holding fabric.

2. The water-holding fabric of claim 1 wherein at least two of the plurality of connecting threads extend between one of the plurality of first loops and one of the plurality of second loops.

3. The water-holding fabric of claim 1 wherein at least two of the plurality of connecting threads extend between one of the plurality of first loops and more than one of the plurality of second loops.

4. The water-holding fabric of claim 1 wherein a first predetermined number of the plurality of connecting threads have a length greater than those of a second predetermined number of the plurality of connecting threads, such that they are slack when the second predetermined number is taut between the first woven surface and the second woven surface.

5. The water-holding fabric of claim 1 wherein at least one of the plurality of first air pores and at least one of the plurality of second air pores at least partially overlap with each other in a direction perpendicular to the first woven surface and the second woven surface.

6. The water-holding fabric of claim 1 wherein at least one of the first weaving thread, the second weaving thread, and the plurality of connecting threads comprises a first filament material, the first filament material having a first depression on its surface, and the first depression extending lengthwise relative to the first filament material.

7. The water-holding fabric of claim 6 wherein at least one of the first weaving thread, the second weaving thread, and the plurality of connecting threads further comprises a second filament material different from the first filament material, having an antibacterial and mildew-proof composition, such that when a plurality of first filaments are provided, the antibacterial and mildew-proof composition is embedded between the first filaments, and having a hydrophilic factor, such that when a plurality of the first filaments are provided, the hydrophilic factor is embedded between the first filaments.

8. A filter comprising a water-holding fabric, the filter comprising:
at least two overlapping woven surfaces comprising a first woven surface and a second woven surface;
wherein the first woven surface comprises a plurality of first air pores, with each of the plurality of first air pores being defined by at least one first weaving thread and a plurality of first loops formed along the at least one first weaving thread;
wherein the second woven surface comprises a plurality of second air pores, with each of the plurality of second air pores being defined by at least one second weaving thread, and a plurality of second loops formed along the at least one second weaving thread; and
a plurality of connecting threads extending between the plurality of first loops and the plurality of second loops, thereby connecting the first woven surface to the second woven surface to form the water-holding fabric of the filter.

9. The filter of claim 8 wherein at least two of the plurality of connecting threads extend between one of the plurality of first loops and one of the plurality of second loops.

10. The filter of claim 8, wherein at least two of the plurality of connecting threads extend between one of the plurality of first loops and more than one of the plurality of second loops.

11. The filter of claim 8, wherein a first predetermined number of the plurality of connecting threads have a length greater than those of a second predetermined number of the plurality of connecting threads, such that they are slack when the second predetermined number is taut between the first woven surface and the second woven surface.

12. The filter of claim 8, wherein at least one of the plurality of first air pores and at least one of the plurality of second air pores at least partially overlap with each other in a direction perpendicular to the first woven surface and the second woven surface.

13. The filter of claim 8 wherein at least one of the first weaving thread, the second weaving thread, and the plurality of connecting threads comprises a first filament material, the first filament material having a first depression on its surface, and the first depression extending lengthwise relative to the first filament material.

14. The filter of claim 13 wherein at least one of the first weaving thread, the second weaving thread, and the plurality of connecting threads further comprises a second filament material different from the first filament material, having an antibacterial and mildew-proof composition, such that when a plurality of first filaments are provided, the antibacterial and mildew-proof composition is embedded between the first filaments, and having a hydrophilic factor, such that when a plurality of the first filaments are provided, the hydrophilic factor is embedded between the first filaments.

15. The filter of claim 8 wherein the filter comprises multiple overlapping water-holding fabrics.

16. The filter of claim 8 wherein the filter is incorporated into a humidifier.

17. A method for manufacturing a water-holding fabric, the method comprising:
preparing a first woven surface with at least one first weaving thread to form a plurality of first air pores, with each of the plurality of first air pores defined by a plurality of first loops;
preparing a second woven surface with at least one second weaving thread to form a plurality of second air pores, with each of the second air pores defined by a plurality of second loops; and
arranging at least one connecting thread to extend between at least one of the plurality of first loops and at least one of the plurality of second loops, thereby connecting the first woven surface and the second woven surface.

18. The method of claim 17 wherein no fewer than five of the connecting threads extend between one of the plurality of first loops and a one of the plurality of second loops.

19. The method of claim 17 wherein a plurality of the connecting threads extends between one of the plurality of the first loops and at least two of the plurality of second loops.
